(19) United States
(12) Patent Application Publication
(10) Pub. No.: US 2008/0148754 A1
(43) Pub. Date: Jun. 26, 2008

(54) Cryogenic cooling system with energy regeneration

(76) Inventor: Roman Snytsar, Sammamish, WA (US)

Correspondence Address: ROMAN SNYTAR, 3048 218TH AVE. SE, SAMMARNISH, WA, 98075, US

(21) Appl. No.: 11/644,323

(22) Filed: Dec. 23, 2006

(51) Int. Cl. F25D 23/12; F25B 21/02; F25B 27/00; F02G 1/04

(52) U.S. Cl. 62/259.2; 62/238.1; 62/238.2; 62/238.4; 62/3.2; 60/517

(57) ABSTRACT

The invention provides an efficient way of cooling of the microelectronic devices and converting the heat back into the electrical power. With addition of the ambient-air heat exchanger the system generates enough power to completely satisfy the demand of the microelectronic device and replace the electric battery with the cryogenic storage vessel.

### CROSS-REFERENCE TO RELATED APPLICATIONS

None

### FEDERALLY SPONSORED RESEARCH

Not Applicable

### SEQUENCE LISTING OR PROGRAM

Not Applicable

### BACKGROUND OF THE INVENTION

1. Field of Invention

The present application generally relates to the cooling systems, and in particular, the present invention relates to an electrical energy-generating cooling system and to a cryogenic cooling system.

2. Prior Art

Modern microelectronic devices generate substantial amounts of heat during their operation. This presents both the problem and the opportunity.

The problem is the need to remove the heat from the device to avoid overheating. Usually the heat has to be dissipated into the ambient air with the temperature 20-30K below the temperature of the device. This calls for massive heat exchangers with developed surfaces, pumps or fans for the forced convection. Many attempts have been made to cool the microelectronic device with the media colder than the ambient air. This requires a cooler or heat pump that consumes energy and generates even more heat in the vicinity of the device.

The opportunity is to convert the heat back into electric energy and thus reduce the energy consumption from the outer source like battery or power network. For example, in U.S. Pat. No. 6,877,318 to Tadayon et al. (2005) a system is described that uses the micro-machined turbine in the Rankine cycle. The maximum (Carnot) efficiency of the cycle with the worker fluid cooled by ambient air is 9%. Because of the lower efficiency of the Rankine cycle and the losses inherent to the miniature turbines the real efficiency of the system is about 1%. The better efficiency cannot be achieved without introduction of the cryogenic coolants.

Meanwhile significant progress has been made in using the cryogenic liquids and the liquid nitrogen (LN2) in particular for energy storage and generation. It is proven that the specific energy of the liquid nitrogen storage is more than the specific energy of electric batteries. The U.S. Pat. No. 5,390,500 to White et al (1995) describes a multipass heat exchanger that eliminates frost buildup harmful to electronics. The research has concentrated on the systems generating several kilowatts of power for car locomotion, as described for example in U.S. Pat. No. 3,681,609 to Boese et al (1972). No systems are known to use the cryogenic power cycle for micro-power generation.

### SUMMARY

In accordance with the present invention a two stage cooling system with electric energy-generating capability is described. A heat from a heat source, in particular an electronic chip, is converted into electric energy by a first stage conversion device. The residual heat is sunk by the cryogenic liquid that is thus evaporated, heated further by the ambient air heat exchanger and directed into a second stage expander turbine that drives a second stage electric generator.

### DRAWINGS—FIGURES

FIG. 1 is a block diagram showing a system for energy storage, power generation and cooling in one embodiment of the present invention.

FIG. 2 is a block diagram showing a variation of the system with the ambient air heat exchanger moved outside the heat engine.

FIG. 3 is a drawing showing the cross-section elevation of power generating unit with the standing-wave thermoacoustic engine.

FIG. 4 is an enlarged cross-section elevation of the generator coil/heat exchanger combination.

FIG. 5 is a cross-section elevation of the generator coil/heat exchanger combination used in the rotary-type Stirling engine.

FIG. 6 shows the T-S diagram of the cryogenic Rankine cycle.

FIG. 7 shows the power generating unit used as a part of the personal cooling system.

FIG. 8 shows the array of the power generating units used for air cooling and water condensation.

### DRAWINGS—REFERENCE NUMERALS

| | |
|---|---|
| 100 | heat source/microchip |
| 101 | circuit board |
| 200 | cryogenic vessel |
| 201 | pump |
| 300 | heat conversion device |
| 301 | hot heat exchanger |
| 302 | ambient air heat exchanger |
| 303 | cold heat exchanger |
| 310 | thermoacoustic engine case |
| 311 | insulating chamber |
| 312 | coolant chamber |
| 313 | thermoacoustic stack |
| 400 | first stage electric generator |
| 410 | membrane |
| 411 | magnet |
| 412 | generator coil |
| 430 | hot engine part |
| 431 | cold engine part |
| 432 | insulating insert |
| 433 | hot heat exchanger/coil |
| 434 | cold heat exchanger/coil |
| 435 | flywheel |
| 436 | displacer |
| 437 | magnet/counterweight |
| 500 | expander turbine |
| 501 | turbine casing |
| 600 | second stage electric generator |
| 601 | adiabatic expansion process |
| | diagram |
| 602 | isothermic expansion process |
| | diagram |
| 603 | actual process diagram |

### DETAILED DESCRIPTION

I propose a system that uses a vessel with cryogenic liquid for energy storage, cools the microelectronic device with the liquid and generates electric energy by utilizing the heat from the device and from the environment.

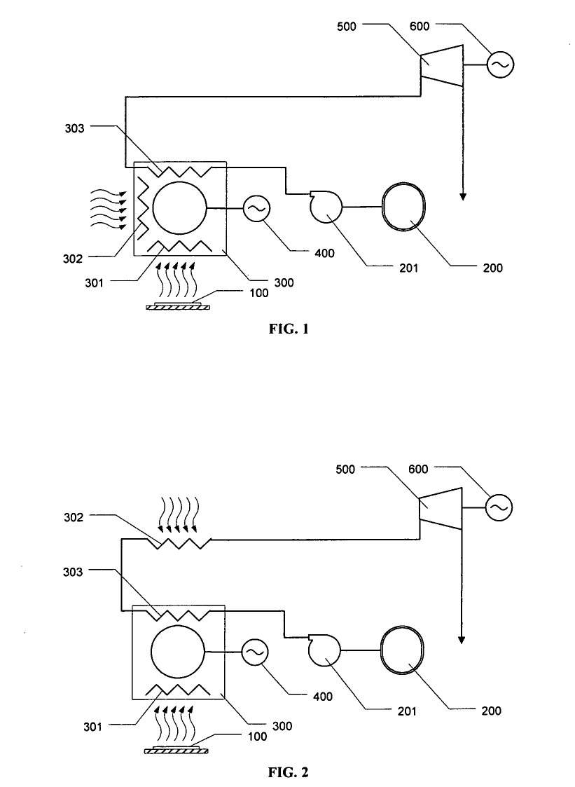

The main components of the system are shown on FIG. 1. Reversible heat engine (e.g. Stirling cycle engine) 300 is equipped with two “hot” heat exchangers. Heat exchanger 301 absorbs heat from the microelectronic device 100 and heat exchanger 302 absorbs heat from the ambient air. Heat is partially converted into the mechanical energy and then into the electrical energy by the electric generator 400. The residual heat is sunk at the “cold” heat exchanger 303. Pump 201 forces the cryogenic liquid from the heat insulated vessel 200 through the heat exchanger 303. There the liquid evaporates and the vapor is superheated to the ambient air temperature. The vapor is directed into the expander type turbine 500 connected to the electric generator 600.

Since only the residual heat from the first stage (heat engine) reaches the cryogenic liquid the specific energies in this binary cycle are very high. For example the available work Q for the liquid nitrogen (LN2) in the Rankine cycle is 769 kJ/kg. The specific energies of LN2 in the open Rankine cycle may reach 300 kJ/kg, which is already comparable with the best available battery technology and is well above the specific energy of the lead-acid or Ni—Cd batteries at 110 kJ/kg. Given Etha1 is the thermal efficiency of the heat engine and Etha2 is the thermal efficiency of the Rankine cycle the specific energy of LN2 “fuel” in binary cycle is

Qe=Q(Etha1/(1−Etha1)+Etha2)

Assuming the thermal efficiency of the heat engine is the same as that of the Rankine cycle the specific energy of LN2 in the binary cycle is 792 kJ/kg.

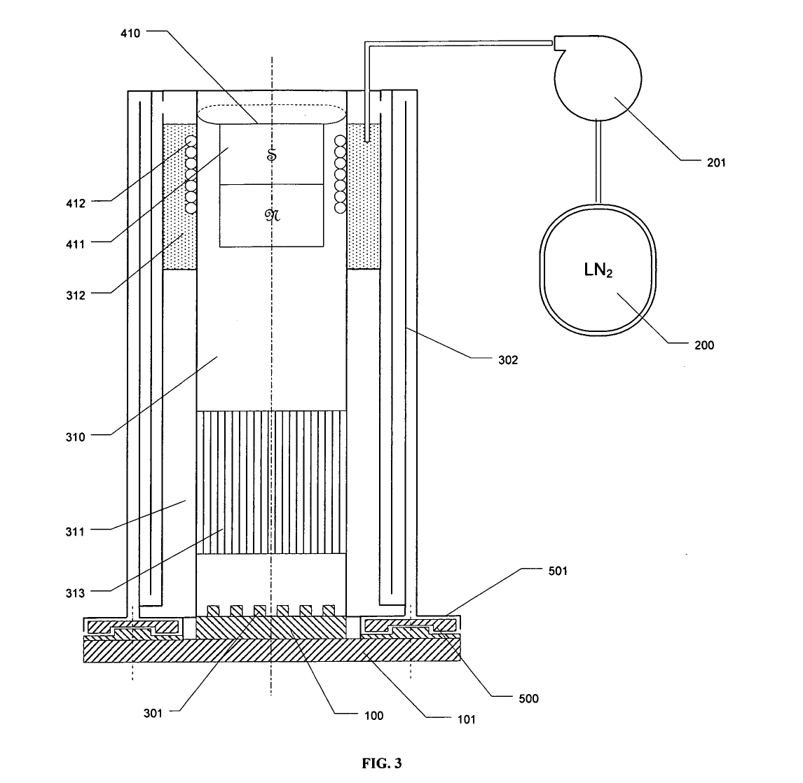

To reduce the complexity, size or cost of the system at the expense of giving up some thermal efficiency, one of the “hot” heat exchangers may be placed outside the heat engine and deliver heat directly to the cryogenic liquid. FIG. 2 shows a variation of the system where the ambient air heat exchanger 302 is placed outside the engine and is used to superheat the vapor evaporated at the heat exchanger 303.

When the microelectronic device is connected to the power grid it is desirable to have an option to conserve the cryogenic liquid “battery” and switch to the main power supply. When the system switches from generation mode to mains powered mode the pump 201 is shut off. As a result turbine 500 and generator 600 halt. Generator 400 is connected to the mains power as a motor and delivers mechanical energy to the reversible heat engine 300 which now operates as a cooler. The heat from the microelectronic device is sunk at the heat exchanger 301 and dissipated from the heat exchanger 302. When the peak cooling performance is required the system may switch back to generating mode.

FIG. 3 shows one possible embodiment of such a system. Microelectronic device 100 is mounted on the circuit board 101. For better heat transfer the top of the device may be equipped with grooves 301. On top of the device sits the tube 310 with double walls divided into two chambers. Lower chamber 311 is evacuated for the purpose of heat insulation. Pump 201 supplies the cryogenic liquid from insulated vessel 200 into the upper chamber 312. Inside the tube rests a stack 313 made of a porous material. Tube and stack form a thermoacoustic engine with the device surface serving as a hot heat exchanger and the inner walls of the upper chamber and coil 412 as a cold heat exchanger. Heat removed from the device is partially converted into the mechanical energy of acoustic wave and partially absorbed by the cryogenic liquid through the walls of the upper chamber.

The mechanical energy is converted to electricity by means of the linear generator. The acoustic wave drives the flexible membrane 410 with the magnet 411 attached to it. Motion of the magnet induces an electric current in the coil 412.

The heat absorbed by the cold heat exchanger causes the liquid to evaporate. The vapor is then directed into the multiple pass heat exchanger 302. The exchanger design prevents frost buildup. The vapor heated to the ambient-air temperature is directed into the expander type microturbine 500 combined with the electrical generator. The expanded vapor (gas) is then released into the ambient air.

In the mains powered mode the alternating electric current in coil 412 causes the magnet 411 and membrane 410 to vibrate. The resulting acoustic wave cools the microchip device.

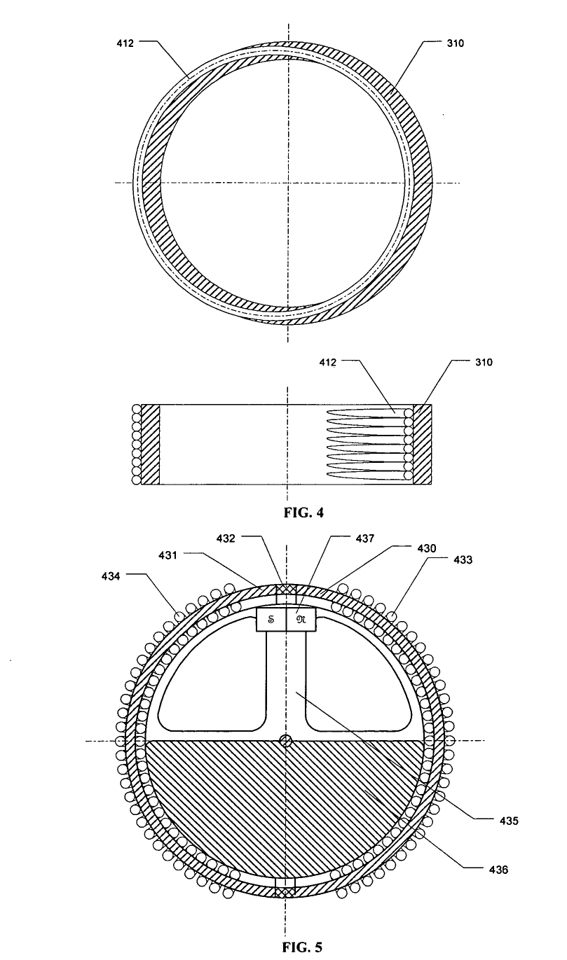

In the design depicted on FIG. 3 the coil 412 serves both as a part of the electric generator and as a heat exchanger. FIG. 4 shows a detailed view of the coil/tube assembly. The windings of the coil work as heat conductors and the large surface of the windings facilitates the heat exchange. The combination of generator windings and heat exchanger reduces weight, size, and cost of the system.

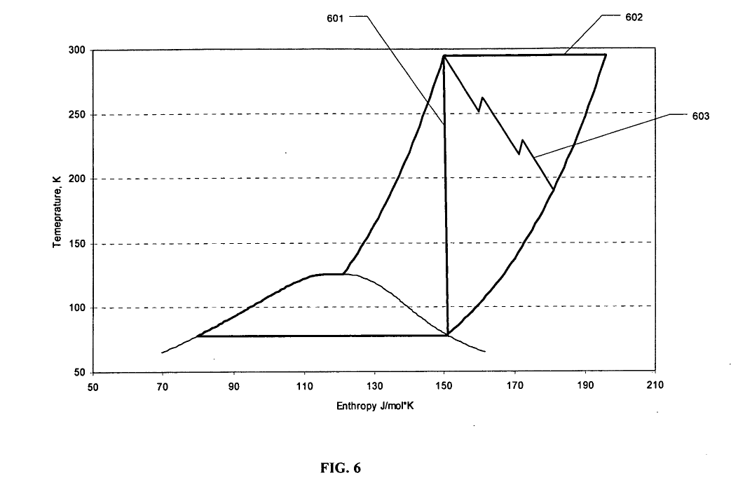

The generator/heat exchanger combination can be used in many different types of heat engines. FIG. 5 shows a cross-section elevation of the displacer chamber of the rotary Stirling cycle engine combined with the electric generator. The cylindrical chamber is divided into cold part 430 and hot part 431 by the heat insulating insert 432. Coils 433 and 434 are threaded through the walls of the cold part and hot part respectively thus enhancing the heat exchange. The displacer 436 and the counterweight magnet 437 are attached to the flywheel 435. During the engine operation the flywheel rotates and the motion of the magnet induces an electric current in coils 433 and 434.

The coil windings may also be used as a regenerator type heat exchanger for example as a thermoacoustic engine stack.

Exposure of the coil windings to the cryogenic temperatures makes possible to use the high temperature superconducting wire and further improve generator efficiency.

One more distinctive feature of the device on FIG. 3 is a turbine casing 501 manufactured from the heat-conductive material. Since the vapor in the turbine is colder than the ambient air then the heat from the ambient air is sunk at the turbine housing thus improving the turbine efficiency.

On FIG. 6 is a T-S diagram of the cryogenic Rankine cycle. The area of the closed loop determines the efficiency of the cycle. If no heat exchange occurs in the turbine then the expansion process is adiabatic and is presented by line 601. At the maximum possible heat exchange rate the gas in the turbine is always at the temperature of the ambient air and the expansion process becomes isothermal (line 602) bringing the performance of the cycle to the maximum possible level. So the heat sinking to the turbine should be maximized.

The high expansion ratio typical for cryogenic vapors will normally require a multitude of micro-turbines connected sequentially. The gas is warmed in between the expansions and the ambient air heat is sunk at every stage. The curve 603 describing the actual process is in between the lines 601 and 602.

The power generating unit is compact and well suited for the mobile applications. It is capable of adjusting the power output to the demands of the microelectronic device. When the power consumption increases the amount of heat sunk at the cold heat exchanger of the engine increases as well. More liquid is evaporated increasing the amount of gas available for the second stage operation. The throughput of the second stage increases and so is the power generated by the second stage. The drop in the power consumption will decrease the throughput of the second stage and conserve the cryogenic liquid.

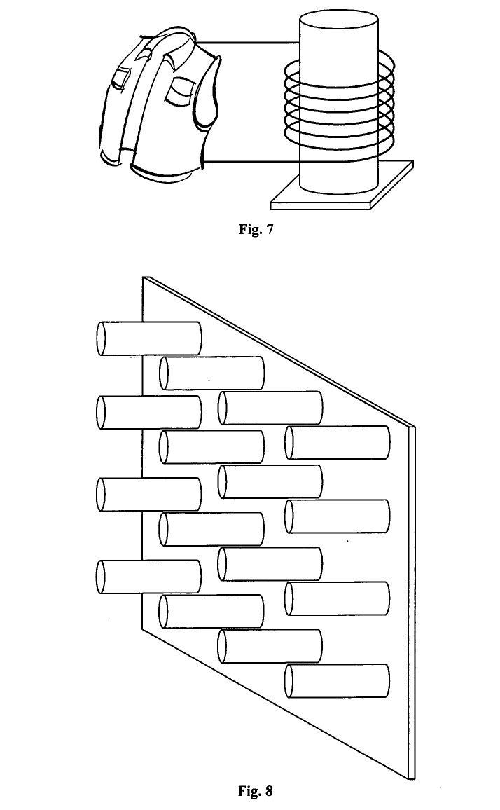

The fact that the unit generates power by sinking the ambient heat allows for using it in the personal cooling system. FIG. 7 shows the unit combined with the cooling vest or collar. The array of the devices shown on FIG. 8 produces electricity, cools a room or tent and also produces distilled water via condensation.

I claim:

1. A machine device comprising:
a cryogenic vessel with coolant,
a heat source,
a hot heat exchanger,
a first stage reversible heat conversion device,
a cold heat exchanger,
a second stage pressure conversion device consisting of at least one expander turbine coupled to an electric generator

2. The device as claimed in claim 1, wherein the heat conversion device is a thermoelectric element

3. The device as claimed in claim 1, wherein the heat conversion device is a thermoacoustic engine coupled to an electric generator

4. The device as claimed in claim 1, wherein the heat conversion device is a Stirling engine coupled to an electric generator

5. The device as claimed in claim 1, wherein the cold heat exchanger serves as an electric coil for the first stage generator

6. The device as claimed in claim 1, wherein the hot heat exchanger serves as an electric coil for the first stage generator

7. The device as claimed in claim 1, wherein an ambient air heat exchanger is introduced between the cold heat exchanger and the second stage pressure conversion device.

8. The device as claimed in claim 7, wherein said ambient air heat exchanger is a no frost multiple pass heat exchanger.

9. The device as claimed in claim 1, wherein the electric generator coils are made of the high temperature superconducting material.

10. The device as claimed in claim 1, wherein the expander turbine casing is made of the material with high thermal conductivity.

11. The device as claimed in claim 1, wherein the coolant is the liquid nitrogen

12. The device as claimed in claim 1, wherein the coolant is the liquid argon

13. The device as claimed in claim 1 wherein said heat source is a person.
